(19) United States
(12) Patent Application Publication
(10) Pub. No.: US 2019/0212471 A1
(43) Pub. Date: Jul. 11, 2019

(54) SILICON BASED MID-IR SUPER ABSORBER USING HYPERBOLIC METAMATERIAL

(71) Applicant: The American University in Cairo, New York, NY (US)

(72) Inventors: Mohamed Swillam, New Cairo (EG); Ahmed M. Mahmoud, New Cairo (EG); Mai Desouky, New Cairo (EG)

(21) Appl. No.: 16/244,778

(22) Filed: Jan. 10, 2019

Related U.S. Application Data
(60) Provisional application No. 62/615,690, filed on Jan. 10, 2018.

(51) Int. Cl. G02B 1/00; G02B 5/00

(52) U.S. Cl. CPC G02B 1/002; G02B 5/003

(57) ABSTRACT

An absorber for energy harvesting is provided comprising a structure of a multilayered N-doped Si/Si hyperbolic metamaterial (HMM) integrated with a sub-hole Si grating, wherein the structure has a tunable absorption peak tunable from 4.5 μm to 11 μm through changing the grating parameters.

### CROSS-REFERENCE TO RELATED APPLICATIONS

This application claims priority from U.S. Provisional Patent Application 62/615690 filed Jan. 10, 2018, which is incorporated herein by reference.

### FIELD OF THE INVENTION

The present invention relates generally to absorbers for energy harvesting. More particularly, the invention relates to a Silicon (Si) based mid IR super absorber.

### BACKGROUND OF THE INVENTION

Perfect absorbers are indispensable components for energy harvesting applications. While many absorbers have been proposed, they encounter inevitable drawbacks including bulkiness or instability over time. The urge for a CMOS compatible absorber that can be integrated for on-chip applications requires further investigation.

### SUMMARY OF THE INVENTION

The current invention demonstrates a Silicon (Si) based mid IR super absorber with absorption (A) reaching 0.948. In one embodiment, the structure is composed of multilayered N-doped Si/Si hyperbolic metamaterial (HMM) integrated with sub-hole Si grating. In another embodiment, the structure has a tunable absorption peak that can be tuned from 4.5 μm to 11 μm through changing the grating parameters. In a further embodiment, the invention includes two grating designs integrated with N-doped Si/Si HMM that can achieve wide band absorption. The first grating design is based on Si grating incorporating different holes' height with (A) varying between 0.83 and 0.97 for wavelength from 5 μm to 7 The second grating design is based on Si grating with variable holes' diameter; the latter shows broad band absorption with the maximum (A) reaching 0.97. Shown here is that the structure is omnidirectional. The current invention is an all Si based absorber, which demonstrates a good candidate for thermal harvesting application.

Demonstrated herein is a mid-IR Si based super absorber of total thickness not exceeding 1 microns using HMM integrated with sub-hole Si grating. Single band absorption was achievable with (A) reaching 0.948. The invention is able to tune the absorption peak over the mid-IR range from 4.5 to 11 μm by either changing the grating hole's height or by changing the hole's diameter. The disclosure confirms that the invention is an omnidirectional and less- polarization dependent absorber. One embodiment has profound application in bio and chemical sensing mechanisms based upon tuning the single absorption peak of predesigned grating. Show herein is that BBA can be achieved by using an all Si based structure. The disclosed two grating designs, namely: Si grating with different holes' height and Si grating with different holes' diameter, both are integrated with the N-doped Si/Si HMM. Both designs have acquired BBA with maximum (A) reaching 0.97. I For Metamaterial fabrication, standard chemical vapor deposition can be applied for Si layers deposition while ion beam irradiation can be used to dope the Si layers. For patterning both the periodic grating or the multiple diameters' hole grating, photolithography and deep reactive ion etching can be used. For grating of different hole heights', Nano imprint lithography can be used to pattern a stair case grating followed by photolithography and deep reactive ion etching. This absorber opens avenues for CMOS compatible energy harvesters for on chip purposes. The invention addresses the need for an on-chip CMOS compatible energy harvesters.

### DETAILED DESCRIPTION

Other examples, applications and/or embodiments are described in U.S. Provisional Patent Application 62/615,690 filed Jan. 10, 2018, which is incorporated herein by reference.

What is claimed is:

1. An absorber for energy harvesting, comprising a structure of a multilayered N-doped Si/Si hyperbolic metamaterial (HMM) integrated with a sub-hole Si grating, wherein the structure has a tunable absorption peak tunable from 4.5 μm to 11 μm through changing the grating parameters.
